(19) United States
(12) Patent Application Publication
(10) Pub. No.: US 2018/0259106 A1
(43) Pub. Date: Sep. 13, 2018

(54) MODULE FOR TRANSPORTING A FLUID AND METHOD OF CONNECTING A WOVEN STRUCTURE AND AN END CONNECTOR

(71) Applicant: ETS A. DESCHAMPS ET FILS, La Couronne (FR)

(72) Inventor: Georges-Paul DESCHAMPS, Voeuil et Giget (FR)

(21) Appl. No.: 15/976,283

(22) Filed: May 10, 2018

Related U.S. Application Data
(63) Continuation of application No. PCT/EP2016/076165, filed on Oct. 28, 2016.

(30) Foreign Application Priority Data
Nov. 10, 2015 (EP) 15306789.7

(51) Int. Cl. F16L 33/32; F16L 11/02; F16L 33/30

(52) U.S. Cl. CPC F16L 33/32; F16L 33/30; F16L 11/02

(57) ABSTRACT

Disclosed is a module for transporting a fluid, including a woven structure forming a tubular pipe and at least one end connector placed at one end of the woven structure, the end connector including a main body delimiting an internal channel for the passage of the fluid. According to the invention, the internal wall of the body delimiting the channel, or the external wall of the body delimiting the external lateral surface of that body, being annular and having at least one shoulder defining an internal, respectively external, bearing face for the reception of at least one ring, the free end of the woven structure is anchored in the connector only by friction of the faces of the free end with the surfaces of the ring or rings and the internal, respectively external, wall of the main body.

### BACKGROUND OF THE INVENTION

### Field of the Invention

The present invention concerns a module for transporting a fluid, notably seawater.

It further concerns a method of connecting a woven structure and an end connector as well as a device for executing that method.

### Technological Background

It is known to use flexible pipes in a marine environment for transporting a fluid, notably hydrocarbons or seawater.

These pipes installed at great depth must resist very high tensions. This is notably the case of so-called risers connecting a floating structure situated at the surface to the seabed.

The weight of these very long risers generates very high tensions, notably in traction, in the upper part thereof.

It is therefore imperative to be able to limit the weight of these pipes.

It is known to place an end connector at each end of each pipe.

The use of an end connector of this kind not only absorbs the forces exerted on the pipe but also makes it possible to assemble pipes to one another.

Of course, the traction forces exerted on the pipe are transmitted to each end connector.

The connection of the pipe to its end connector must therefore have a high resistance to pulling out.

To this may be added the oscillatory movement of the floating structure at the surface, linked to the sea state, for example in the case of swell, which may lead to increased fatigue of the pipe/end connector connection. Under extreme conditions, this movement can lead to a high risk of pulling out.

Various technical solutions have been proposed to attempt to overcome these technical problems.

For example, it is known to embed the free end of the pipe in a hardenable polymer material injected into a chamber provided for this purpose in the corresponding end connector.

The coating formed after hardening of the polymer traps the free end of the pipe in this chamber in the end connector.

However, it is found that the prior art solutions typically lead to deterioration of the flexible pipes.

A weakening of the mechanical strength of this flexible pipe is observed when some wires of the free end of the flexible pipe are damaged or even cut, for example by passing through it the shank of a fastener.

Be this as it may, separating the flexible pipe and its end connector always requires the destruction of one or even both parts. This results in a non-negligible overcost for the operator.

Finally, these prior art solutions do not guarantee a homogeneous mechanical strength over the whole of the flexible pipe/end connector connection.

There is therefore a pressing need for a lighter flexible pipe and for an end connector with increased resistance to pulling out from the pipe.

### OBJECT OF THE INVENTION

The present invention aims to remedy the drawbacks of the prior art by proposing a module for transporting a fluid that is of simple design and simple to use, light in weight and economical, addressing the disadvantages referred to above.

In particular, the present invention consists in a module for transporting a fluid the end connector of which has an increased resistance to pulling it out of the flexible pipe at the same time as preserving the integrity of the latter.

The present invention further consists in a module of the above kind the various component parts of which can be demounted without damaging them.

### SUMMARY OF THE INVENTION

To this end, the invention concerns a module for transporting a fluid, comprising a woven structure forming a tubular pipe and at least one end connector placed at one end of said woven structure, said end connector comprising a main body delimiting an internal channel for the passage of said fluid.

According to the invention, the internal wall of said body delimiting said channel, or the external wall of said body delimiting the external lateral surface of that body, being annular and having at least one shoulder defining an internal, respectively external, bearing face for the reception of at least one ring, the anchoring of the free end of said woven structure in said connector is obtained only by friction of the faces of said free end with the surfaces of said ring or rings and said internal, respectively external, wall of said main body.

Of course, this module can consist of a woven structure including an end connector at each of its ends.

The woven structure may be coated or receive in its central part reinforcing elements such as rods to stiffen it and to prevent it from being crushed. However, to ensure the lightness of each module, each end connector of the module is assembled only to the woven structure forming a tubular pipe. A notable result of this is that the latter is not surrounded by a metal or other material external skin.

This woven structure may notably be coated to seal it. For example, the coating is performed by a coating method employing polyurethane.

It results from the definition of the module that, each free end of the woven structure being trapped in the central part of a connector and the annular bearing face being internal to each connector, the body of this end connector is outside the corresponding woven structure. Alternatively, each free end of the woven structure being trapped at the perimeter of each connector and the annular bearing face being outside each connector, the body of this end connector is inside the corresponding woven structure.

The main body of each end connector is preferably in one piece and therefore is not the result of assembling initially separate parts.

It should be remembered that a shoulder is a change in the section of a part, here the main body of the connector, producing a face intended to serve as a bearing face for another part, here the rings.

It should also be remembered that this woven structure is flexible.

Each ring is a one-piece solid or hollow annular part. It is not necessarily closed.

Moreover, when said at least one shoulder is placed in the internal channel of the connector and the main body of the connector is therefore outside the woven structure, each ring may include a plurality of ring portions or sectors in order to facilitate their assembly. These ring portions are simply placed end-to-end to form the corresponding ring. The stresses exerted on these ring portions at sea and at depth ensure the assembly thereof without it being necessary to use attachments or other means.

At least one of these rings preferably has an empty internal space making it possible to press the free end of the woven structure against the internal or external lateral wall of the main body of the connector to generate friction. When the rings are placed one beside the other on the bearing face, they are advantageously concentric and in contact or substantially in contact so as to generate friction when the free end of the woven structure is engaged between them.

For example, these rings may be made of a metal, such as steel, of a non-deformable plastic material or of composite materials.

If the wires of the free end of the woven structure have not been coated beforehand, anchoring is obtained only by the friction of these wires with the surfaces of each ring and of said internal or external wall of the main body.

When these wires are coated, anchoring is obtained by the friction of the coating surface, i.e. of the surface of the free end of the woven structure coated in this way, with the surfaces of each ring and of said internal or external wall of the main body.

In various particular embodiments of this module, each having its particular advantages and lending itself to numerous possible technical combinations:
said connector comprising at least two rings, said rings are received on said bearing face and superposed or placed in contact one alongside the other to trap the corresponding free end of said woven structure.
said connector including two rings, the free end of said woven structure envelops said rings and is engaged between them to trace out an S, said engagement increasing the resistance to sliding of the faces of said free end.

Of course, the engagement of the free end of said woven structure with said rings may be any other shape.
said connector includes a part for fixing it to a connector of another module or to a floating structure.

This fixing part advantageously presses the portion of the free end of the woven structure covering the ring placed face-to-face with this fixing part with which it comes into contact to further increase the friction.
at least one of said rings has a solid or hollow cross section of regular or irregular polygonal shape.

For example, the shape of this cross section is chosen in the group comprising a square, a rectangle, a parallelogram, a trapezium.
said rings have identical cross sections.

Of course, the rings may have different cross sections.
at least one of said rings has chamfered edges to prevent damaging the free end of said woven structure.

These edges therefore have no projecting corners or sharp edges. The chamfers are preferably rounded.
the external surface of at least one of said rings includes a non-slip coating and/or a surface relief making it possible to increase the coefficient of friction between the faces of the free end of said woven structure and said ring.

For example, the bearing surface of the ring may have alternating crests and grooves that are covered by a thin layer of a hard material with a high coefficient of friction. This thin layer is thin so as not to modify the surface state of the bearing surface of the ring. For example, each ring being made of metal, this thin layer is a layer of titanium nitride, which is known to have excellent adhesion.

Alternatively, the bearing face of the ring may have striations, diamond points, etc.
the free ends of said woven structure have a distinct weave and/or different weft threads from the central part of said woven structure to allow an elastic variation of the diameter of said woven structure.

This elastic variation may consist in an increase or a decrease in the size of the free end of said woven structure when it is engaged in said end connector. The weave of each free end is preferably a plain weave. Of course, the end weaves of the woven structure need not be identical.

Said weft threads of each free end of said woven structure are advantageously made of a material that is more elastic than that constituting the weft threads of the central part of said woven structure.
the free end of said woven structure includes individual woven parts forming a corolla, each woven part being obtained by cutting weft threads of said free end,
said woven structure forming a tubular pipe for transporting a fluid is a one-piece three-dimensional woven structure.

Said woven structure preferably includes in its central part elongate elements, said elongate elements being integrated into said woven structure and aligned on the periphery of that structure to form at least one circumferential line or helix and having their main axis perpendicular or substantially perpendicular to the longitudinal axis of said woven structure. For example, these elongate elements are tubes enabling the passing through the woven structure of attachments for fixing stiffener rods to stiffen this woven structure in order to resist crushing.
said woven structure delimiting an internal channel, said woven structure comprises one or more elements integrated into said woven structure, each of said integrated element being at least partly tubular and passing through said woven structure to enable a communication between said internal channel and the outside part of said woven structure.

Preferably, each integrated element is chosen in the group comprising an insert, a tube, a tube equipped with a transversal sealing membrane, a tube whose inner wall is threaded and combinations thereof.

Advantageously, at least one of said integrated elements, placed at the free end of said woven structure, is placed face-to-face with a ring or with said corresponding main body and in that, said module comprises an attachment mean, at least part of said attachment mean passing through said integrated element so as to ensure an assembly of said woven structure and said ring or said corresponding main body.

By way of example, said attachment mean can be a rivet. Preferably, one integrated element or a group of integrated elements is maintained in position by being trapped between two consecutive weft threads and two consecutive warp threads.

The present invention also concerns a flexible pipe for transporting a fluid, for example seawater, comprising a plurality of modules as described above assembled to one another.

In each connector of said pipe, said shoulder is preferably placed on the internal wall of the corresponding main body so that, the bearing face therefore being internal, a free end of said corresponding woven structure is anchored in the internal channel of said connector and said woven structures of the various modules assembled in this way define a continuous path for the passage of said fluid, the latter therefore being only in contact with said woven structures when it is being transported.

This advantageously prevents said connectors from being able to modify significantly the temperature of the fluid flowing in said flexible pipe. This therefore eliminates thermal bridges. Moreover, the fluid transported being at no time in contact with the end connectors, fluids may advantageously be transported that would be incompatible with a constituent material of the connectors.

Note moreover the absence of head loss or modification of the flow, no areas where debris can accumulate.

The present invention also concerns a method of connecting an end connector and a woven structure defining a fluid transport tubular pipe, said end connector comprising a main body delimiting an internal channel for the passage of said fluid.

According to the invention, the internal wall of said body delimiting said channel or the external wall of said body delimiting its external lateral surface, being annular and having at least one shoulder defining an internal, respectively external, bearing face for receiving two rings, which are intended to be received on said bearing face and stacked or placed in contact alongside one another to trap the corresponding free end of said woven structure, said method includes the following steps:
a) the free end of said woven structure is inserted between the assembly formed by said two rings and said internal or external wall of said annular body,
b) the free end of said woven structure is turned over, a first time toward the rear by folding it over said assembly, then, said rings being spaced from one another, a second time by folding it over the ring nearer said bearing surface so that it comes to envelop that ring,
c) the other ring is pressed against the ring enveloped in this way so that the free end of said woven structure is trapped between these two rings, then
d) having engaged the free end of said woven structure between this other ring and the assembly formed by said internal or external wall and a portion of said free end resulting from the step a), the free end of said woven structure is turned back to envelop that other ring, the passage of the free end of said woven structure between these rings defining an S-shape so that the free end of said woven structure is anchored in said connector only by friction of the faces of said free end with the surfaces of said rings and said internal, respectively external, wall of said annular body.

A fixing part is preferably assembled to said main body, said fixing part coming to press the free end of said woven structure onto the ring that it envelops at least partly.

Beforehand, weft threads of the free end of said woven structure are advantageously cut to define individual woven parts so as to facilitate the engagement of said free end in said connector.

The present invention further concerns a device for executing the method as described above of connecting an end connector and a woven structure defining a fluid transport tubular pipe.

According to the invention:
this device comprises an annular wall defining a central area for receiving said woven structure,
the external lateral surface of said annular wall comprises a support for receiving and supporting said connector and means for individually moving each ring of said connector relative to said internal or external bearing surface.

The upper end of said annular wall preferably includes a rounded rim to facilitate folding the free end of said woven structure.

This annular wall may equally well be surrounded by an annular platform for the movement of operatives.

Each of the means for individually moving a ring advantageously includes arms for holding said ring that are mobile in translation along said annular wall to move the corresponding ring away from or toward said bearing surface whilst being retractable or having an adjustable longitudinal dimension to allow the passage of the free end of said woven structure.

### BRIEF DESCRIPTION OF THE DRAWINGS

Other advantages, objects and particular features of the present invention will emerge from the following description given by way of nonlimiting explanation with reference to the appended drawings, in which:

FIG. 1 is a diagrammatic cross section of an end connector according to a first embodiment of the present invention, the rings not being shown;

FIG. 2 is a partial view in section of the connector from FIG. 1, the free end of a woven structure being engaged and trapped in this connector;

FIG. 3 is a diagrammatic partial perspective view of an end connector according to a second embodiment of the present invention;

FIG. 4 is a partial view in section of the connector from FIG. 3 in which a fixing part covers the basic body and the rings of this connector;

FIG. 5 is a perspective view of a device according to one particular embodiment of the present invention for connecting an end connector and a woven structure defining a fluid transport tubular pipe;

FIG. 6 is a partial view in section of the device from FIG. 5 showing a step of the method of connecting an end connector and a woven structure in which the lower ring of the end connector has been moved after introducing the free end of said woven structure into the connector to trap this free end between the bearing face of the connector and this ring;

FIG. 7 is a partial view in section of the device from FIG. 6, showing a later step of the connection method in which the upper ring has been moved after enveloping the lower ring with the free end of said woven structure so as to be pressed against the lower ring enveloped in this way;

FIG. 8 illustrates a partial and perspective view of an end connector according to a third embodiment of the present invention.

### DETAILED DESCRIPTION OF EMBODIMENT OF THE INVENTION

Firstly, note that the figures are not to scale.

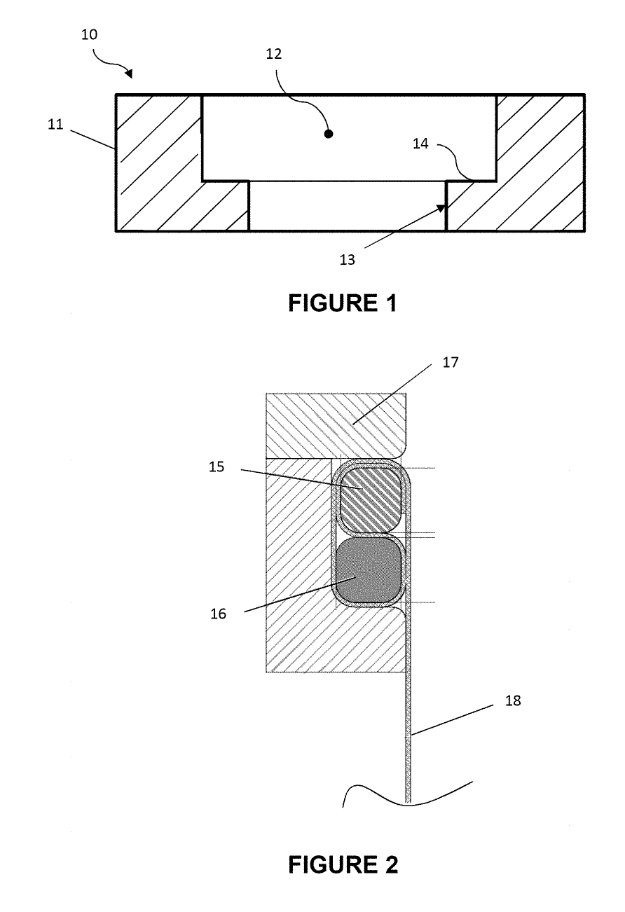

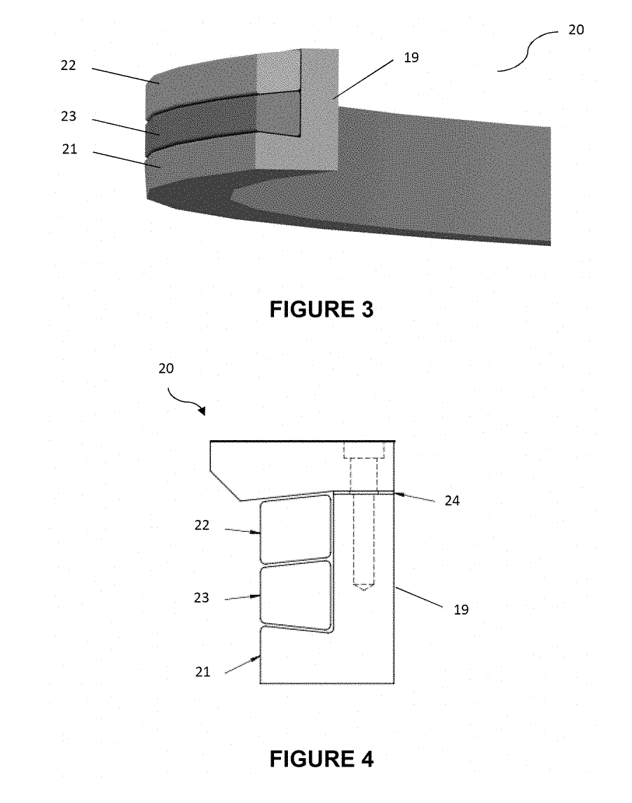

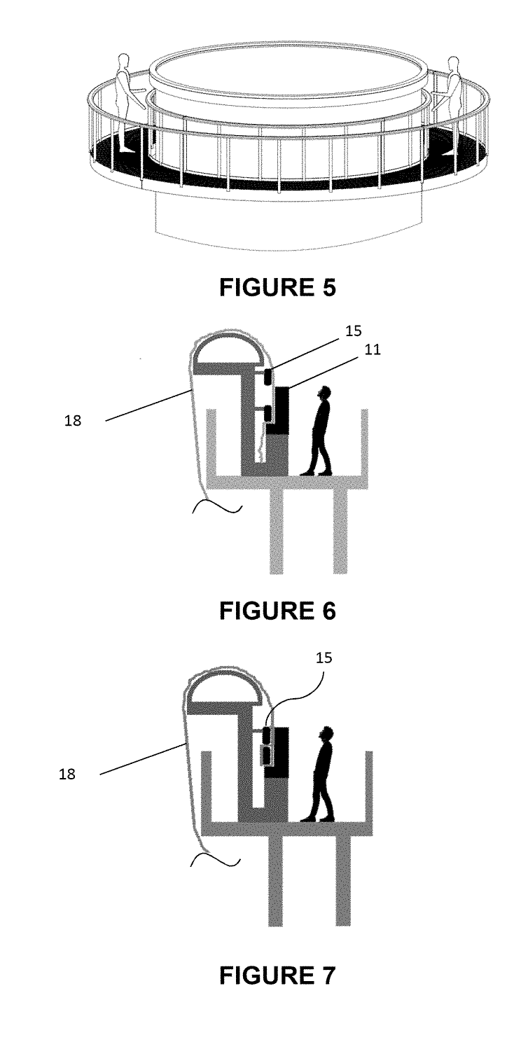

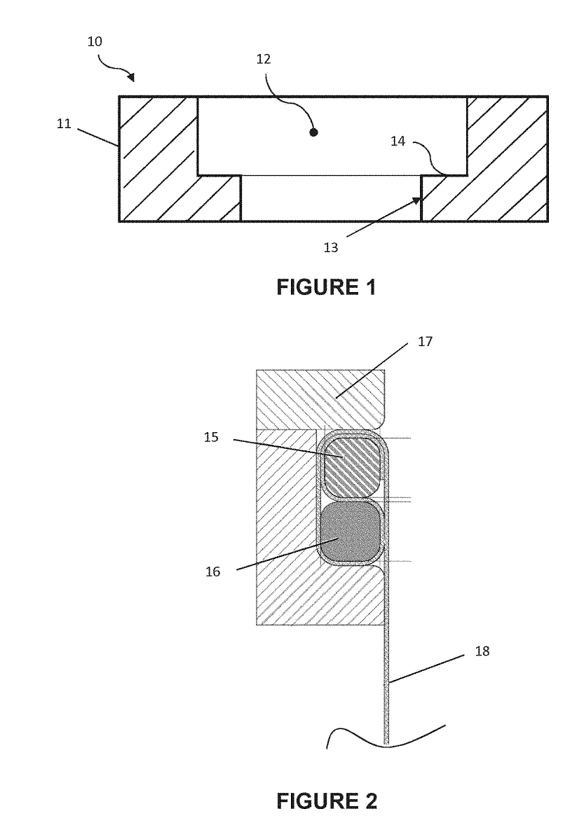

FIGS. 1 and 2 represent diagrammatically a module according to one particular embodiment of the present invention for transporting a fluid, notably seawater.

This module includes a woven structure including at each of its ends a metal end connector 10.

Each connector 10, which here is entirely annular, comprises a main body 11 delimiting an internal channel 12 for the passage of this fluid.

The internal wall of this body 11 delimiting the internal channel 12 being annular, the latter features a shoulder 13 defining an internal bearing face 14 to receive two rings 15, 16.

As represented in FIG. 2, the two rings 15, 16 have identical cross sections of square shape, the edges being chamfered.

The free end of the woven structure 18 envelops these rings 15, 16, being engaged between them in the shape of an S, this engagement increasing the resistance to sliding of the faces of this free end.

Of course, the engagement of the free end of the woven structure 18 in the connector 10 is not limited only to this folding into an S-shape but may be different or simplified.

The free end of said woven structure 18 is therefore anchored in the connector 10 entirely by friction of the faces of this free end of the woven structure 18 with the surfaces of the rings 15, 16 and this internal wall.

In FIG. 2, a fixing part 17, or cap, is represented, which enables assembly of the connector 10 with the connector of another module. Such an assembly may be produced in known manner by welding or bolting.

The free end of the woven structure 18 is therefore anchored in this connector 10 and passes through a portion of the internal channel 12 so that the main body 11 of the connector is outside the woven structure 18.

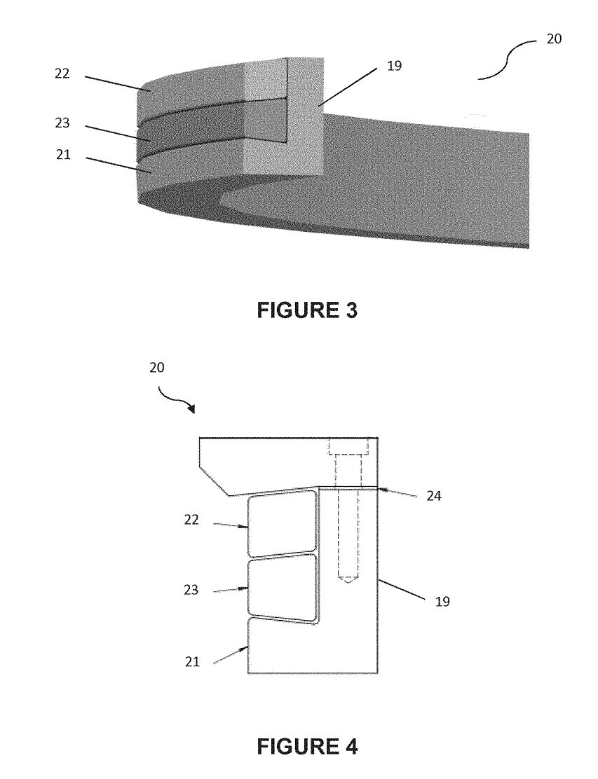

FIGS. 3 and 4 represent diagrammatically a module according to another embodiment of the present invention for transporting a fluid, notably seawater.

Here the shoulder is on the external lateral wall of the main body 19 of the connector 20 so that the bearing face 21 is on or faces toward the outside of the connector 20.

The two rings 22, 23 are received on this bearing face and superposed and pressed one against the other and against this bearing face 21 in order to maximize the friction of the free end of the woven structure 18 engaged in this connector 20.

These metal rings 22, 23, which are solid, have distinct cross sections, a first one having a trapezium shape and the other having a parallelogram shape, so that they rest one on the other and are in contact over the whole of their contact face.

Likewise, the bearing face 21 has a shape complementary to that of the lower ring 23 coming into direct contact with it in order to make contact over the whole of their contact face.

There is therefore maximum friction between the free end of the woven structure 18 engaged in this connector and the surfaces of these rings 22, 23 and the external wall of the main body 19.

The free end of said woven structure 18 is therefore anchored in the connector 20 only by friction of the faces of this free end of the woven structure 18 with the surfaces of the rings 22, 23, this external wall and a fixing part 24.

This fixing part 24 actually has on its internal face a shape complementary to that of the upper ring 22 to press the free end of the woven structure 18 engaged in the connector 20 against the face of this ring 22 and thereby to increase the coefficient of friction.

The free end of the woven structure 18 is therefore anchored in this connector 20 and passes through the external perimeter of the main body of this connector 20 so that the latter is inside the woven structure 18.

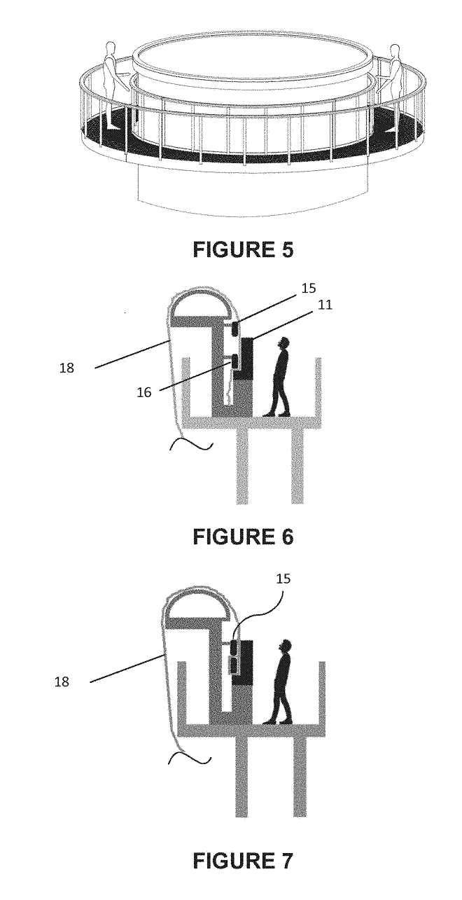

FIGS. 5 to 7 schematically represents a connecting device for connecting an end connector and a woven structure defining a fluid transport tubular pipe.

FIG. 6 is a partial view in section of the device from FIG. 5 showing a step of the method of connecting an end connector 11, 15, 16 and a woven structure 18 in which the lower ring 16 of the end connector has been moved after introducing the free end of said woven structure 18 into the connector to trap this free end between the bearing face of the connector and this ring 16.

FIG. 7 is a partial view in section of the device from FIG. 6, showing a later step of the connection method in which the upper ring 15 has been moved after enveloping the lower ring 16 with the free end of said woven structure 18 so as to be pressed against the lower ring 16 enveloped in this way.

The anchoring of said free end of the woven structure 18 in said connector is thus obtained. This anchoring is achieved only by friction of the faces of said free end with the surfaces of said rings 15, 16 and said internal wall of said main body 11.

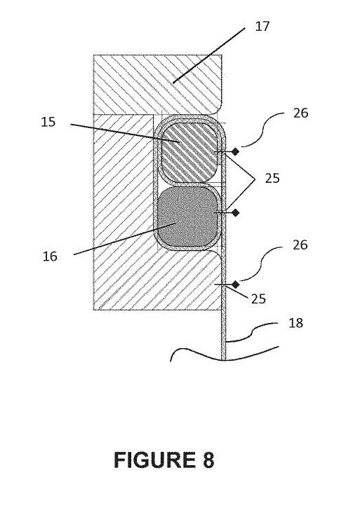

FIG. 8 illustrates a partial and perspective view of an end connector according to a third embodiment of the present invention.

The components of the end connector shown in FIG. 8 having the same references as those illustrated in FIG. 2 represent the same objects, and will not be further described here below.

The end connector shown in FIG. 8 differs from the one illustrated in FIG. 2 in that the woven structure defining a pipe having an internal channel, said woven structure 18 comprises one or more elements 25 integrated into the thickness of said woven structure.

Each integrated element 25 is here a rigid tubular piece, preferably made of a metallic material particularly suited for marine area such as stainless steel.

The ends of each integrated element 25 sits flush with, or sits essentially flush with, the internal and external walls of said woven structure 18. Each integrated element 25 passes through said woven structure 18 to enable a communication between said internal channel and the outside part of said woven structure 18.

Advantageously, the free end of said woven structure comprises one or more integrated elements 25 placed face-to-face with one or said rings 15, 16 and/or of the main body 11 of said connector to ensure that an attachment mean 26 engaged in each integrated element 25 creates a mechanical assembly of said woven structure 18 and said corresponding connector.

Preferably, each integrated element 25 is integrated into the thickness of said woven structure 18 during the manufacture of said woven structure 18.

For this, a method of producing a woven structure 18 comprising at least one woven wall is used, wherein the following steps are carried out:

a) weaving at least one first portion of said woven structure 18, said first portion comprising warp threads and weft threads crossed over each other, or intertwined, according to the fundamental weave of each portion of woven wall corresponding to this first portion,

b) stopping the introduction of the weft threads after the insertion of a weft thread associated with the positioning of at least one integrated element 25 in said woven structure 18, with this weft thread being intertwined with the warp threads of each portion of woven wall according to the fundamental weave of said portion of wall,

c) said at least one integrated element 25 having a main axis, introducing each integrated element 25 between the warp threads defining with the associated said weft thread, the position of insertion of this integrated element 25 into the woven structure, with the main axis of said integrated element 25 cutting the plane passing through the warp threads of each portion of wall into which it is introduced,

d) maintaining in position integrated element 25 and introducing at least one new weft thread intertwining the warp threads of said woven structure 18 according to said fundamental weave of each portion of wall or according to at least one new weave, in order to resume the production of said woven structure, with each elongated element not being taken in said woven structure 18.

When then woven structure 18 comprises several walls, the wall portions can have the same fundamental weave or on the contrary separate weaves for at least some of them.

In a known manner, those skilled in the art know that to represent “the weave” of a fabric, use is made of the method known as producing a weave diagram, which uses a paper with grid pattern, and, by definition, it is admitted that the vertical interlines of the grid pattern show the warp threads, and the horizontal interlines, the weft threads, or pick of the fabric.

If, on such a grid pattern, it is desired to show that a warp thread moves over a weft thread, it is then sufficient, by convention, to colour the box, or square, placed at the intersection of the warp thread and of the weft thread under consideration. This is referred to as a “taken”, also known as a “riser”.

The absence of colouration of a box, which corresponds to a “left”, also known as a “sinker”, symbolises the passing of the warp thread under the corresponding weft thread.

This weave diagramming method, particularly simple, as such makes it possible via a judicious combination of “takens” and “lefts”, to represent all the respective movements of the warp threads and of the weft threads of a woven wall or of a fabric, as complicated as they may be.

As the term “taken” of the step d) of the method must be interpreted with this meaning, it is clear from the technical definition of the method that each integrated element 25 introduced into the woven structure 18 is naturally not linked to this woven structure 18 by only the weaving of the woven structure. As such, and in the absence of an attaching step separate from the weaving of the woven structure 18 properly speaking, such a gluing of the elongated element to the warp and weft threads surrounding it, each integrated element 25 can be withdrawn from the woven structure.

Of course, this operation can be made more or less complex according to the compaction of the weft threads of the woven structure 18 desired, which can result in a more or less substantial tightening of the integrated element 25.

The woven walls, or layers, of the woven structure 18 can be identical or, on the contrary, have for at least some of them, different dimensions or shapes.

The stopping of the weaving in order to introduce one or several elongated elements into the woven structure 18 is therefore detected with respect to the weft thread directly associated with the position of the or of these elongated elements in the woven structure 18. This means that this weft thread is one of the threads of the woven structure 18 surrounding the elongated element or elements. Of course, the steps b) to d) are repeated each time that one or several new elongated elements, of which the position or positions are associated with another weft thread of the woven structure, are to be introduced into this woven structure 18. These operations therefore require determining beforehand what the weft thread is, or what the weft threads are, of the woven structure 18 associated with the positioning of one or several elongated elements in this structure. A monitoring of the guiding and of the introducing of these weft threads into each channel of the weaving loom is also necessary in order to trigger the stopping of the weaving. However, such a method allows for very precise positioning, as it is to the nearest wire, of an integrated element 25 in the woven structure 18 without mechanically weakening the latter.

1. Module for transporting a fluid, comprising a woven structure (18) forming a tubular pipe and at least one end connector (10) placed at one end of said woven structure (18), said end connector (10) comprising a main body (11) delimiting an internal channel (12) for the passage of said fluid, wherein
the internal wall of said body (11) delimiting said channel (12), or the external wall of said body (11) delimiting the external lateral surface of that body, being annular and having at least one shoulder (13) defining an internal, respectively external, bearing face (14) for the reception of at least one ring (15, 16),
the anchoring of the free end of said woven structure (18) in said connector (10) is obtained only by friction of the faces of said free end with the surfaces of said ring or rings (15, 16) and said internal, respectively external, wall of said main body (11).

2. Module according to claim 1, wherein said connector comprising at least two rings (15, 16), said rings are received on said bearing face (14) and superposed or placed in contact one alongside the other to trap the corresponding free end of said woven structure (18).

3. Module according to claim 2, wherein said connector (10) including two rings (15, 16), the free end of said woven structure (18) envelops said rings (15, 16) and is engaged between them to trace out an S, said engagement increasing the resistance to sliding of the faces of said free end.

4. Module according to claim 1, wherein said connector (10) includes a part (17) for fixing it to a connector of another module or to a floating structure.

5. Module according to claim 1, wherein at least one of said rings (15, 16) has a solid or hollow cross section of regular or irregular polygonal shape.

6. Module according to claim 1, wherein said rings (15, 16) have identical cross sections.

7. Module according to claim 1, wherein at least one of said rings (15, 16) has chamfered edges to prevent damaging the free end of said woven structure (18).

8. Module according to claim 1, wherein the external surface of at least one of said rings (15, 16) includes a non-slip coating and/or a surface relief making it possible to increase the coefficient of friction between the faces of the free end of said woven structure (18) and said ring.

9. Module according to claim 1, wherein the free ends of said woven structure (18) have a distinct weave and/or different weft wires from the central part of said woven structure (18) to allow an elastic variation of the diameter of said woven structure (18).

10. Module according to claim 9, wherein the weave of each free end is a plain weave.

11. Module according to claim 9, wherein said weft wires of each free end of said woven structure (18) are made of a material that is more elastic than that constituting the weft wires of the central part of said woven structure (18).

12. Module according to claim 1, wherein the free end of said woven structure (18) includes individual woven parts forming a corolla, each woven part being obtained by cutting weft wires of said free end.

13. Module according to claim 1, wherein said woven structure (18) forming a tubular pipe for transporting a fluid is a one-piece three-dimensional woven structure.

14. Flexible pipe for transporting a fluid, for example seawater, comprising a plurality of modules according to claim 1 assembled to one another.

15. Flexible pipe according to claim 14, wherein, for each connector (10) of said pipe, said shoulder is placed on the internal wall of the corresponding main body (11) so that the bearing face (14) therefore being internal, a free end of said corresponding woven structure is anchored in said connector and enters its internal channel, and wherein said woven structures of the various modules assembled in this way define a continuous path for the passage of said fluid, the latter therefore being only in contact with said woven structures when it is transported.

16. Method of connecting an end connector (10) and a woven structure (18) defining a fluid transport tubular pipe, said end connector (10) comprising a main body (11) delimiting an internal channel (12) for the passage of said fluid, wherein the internal wall of said body delimiting said channel (12) or the external wall of said body delimiting its external lateral surface, being annular and having at least one shoulder (13) defining an internal, respectively external, bearing face (14) for receiving two rings (15, 16), which are intended to be received on said bearing face (14) and stacked or placed in contact alongside one another to trap the corresponding free end of said woven structure (18), said method includes the following steps:
a) the free end of said woven structure (18) is inserted between the assembly formed by said two rings (15, 16) and said internal or external wall of said annular body,
b) the free end of said woven structure (18) is turned over, a first time toward the rear by folding it over said assembly, then, said rings (15, 16) being spaced from one another, a second time by folding it over the ring nearer said bearing surface (14) so that it comes to envelop that ring,
c) the other ring is pressed against the ring enveloped in this way so that the free end of said woven structure (18) is trapped between these two rings (15, 16), then
d) having engaged the free end of said woven structure (18) between this other ring and the assembly formed by said internal or external wall and a portion of said free end resulting from the step a), the free end of said woven structure (18) is turned back to envelop that other ring, the passage of the free end of said woven structure (18) between these rings (15, 16) defining an S-shape so that the free end of said woven structure (18) is anchored in said connector (10) only by friction of the faces of said free end with the surfaces of said rings (15, 16) and said internal, respectively external, wall of said annular body.

17. Method according to claim 16, wherein a fixing part is assembled to said main body, said fixing part coming to press the free end of said woven structure (18) onto the ring that it envelops at least partly.

18. Method according to claim 16, wherein beforehand, weft wires of the free end of said woven structure (18) are cut to define individual woven parts so as to facilitate the engagement of said free end in said connector (10).

19. Device for executing the method according to claim 16 of connecting an end connector (10) and a woven structure (18) defining a fluid transport tubular pipe, wherein:
it comprises an annular wall defining a central area for receiving said woven structure (18),
the external lateral surface of said annular wall comprises a support for receiving and supporting said connector (10) and means for individually moving each ring of said connector (10) relative to said internal or external bearing surface (14).

20. Device according to claim 19, wherein each of the means for individually moving a ring (15, 16) includes arms for holding said ring that are mobile in translation along said annular wall to move the corresponding ring (15, 16) away from or toward said bearing surface (14) whilst being retractable or having an adjustable longitudinal dimension to allow the passage of the free end of said woven structure (18).
